(19) United States
(12) Patent Application Publication
(10) Pub. No.: US 2009/0173088 A1
(43) Pub. Date: Jul. 9, 2009

(54) Condenser and metering device in refrigeration system for saving energy

(76) Inventors: Kuojui Su, Van Nuys, CA (US); Ling Ju Su, Van Nuys, CA (US)

Correspondence Address: DAVID AND RAYMOND PATENT FIRM, 108 N. YNEZ AVE., SUITE 128, MONTEREY PARK, CA, 91754, US

(21) Appl. No.: 12/151,032

(22) Filed: May 2, 2008

Related U.S. Application Data
(60) Provisional application No. 61/010,018, filed on Jan. 4, 2008.

(51) Int. Cl. F25D 15/00; F25B 39/04; F25B 39/00; F25B 39/02; G05D 7/06

(52) U.S. Cl. 62/119; 62/506; 62/507; 62/504; 700/282

(57) ABSTRACT

A refrigeration system includes an evaporator, a compressor compressing a refrigerant coming out of the evaporator, a condensing unit which includes a finned tube guiding the refrigerant from the compressor back to the evaporator; and an energy saving arrangement. The energy saving arrangement includes a water-cooling device frequently introducing a predetermined amount of water to a surface of the finned tube to water-cool the refrigerant within the finned tube for enhancing a cooling efficiency of the condensing unit while being energy efficient. The energy saving arrangement further includes a metering device for controllably pumping the refrigerant from the condensing unit to the evaporator especially when a pressure inside the condensing unit is lower than a threshold pressure.

### CROSS REFERENCE OF RELATED APPLICATION

This is a non-provisional application of a provisional application having an application No. 61/010,018 and a filing date of Apr. 4, 2008.

### BACKGROUND OF THE PRESENT INVENTION

1. Field of Invention

The present invention relates the refrigeration system, and more particularly to a condenser and a metering device incorporated in the refrigeration system to enhance the efficiency thereof and to save energy.

2. Description of Related Arts

A typical refrigeration system, such as an air conditioner (cooling), a freezer or a refrigerator, includes four main components: a compressor, a condenser, a metering device, and an evaporator. The compressor compresses the gas refrigerant from the evaporator into the condenser. The condenser, which is installed outside the room, ejects the heat out of the gas refrigerant and condenses the gas refrigerant, turning gas into liquid refrigerant. The metering device controls the amount of liquid refrigerant running from the condenser to the evaporator. The evaporator, which is installed inside the room, absorbs the heat from the room. As the heat is being absorbed, the liquid refrigerant turns into gas refrigerant and gets compressed again as it passes through the compressor for the next refrigeration cycle.

A colder condenser in a refrigeration system enables the compressor to compress the gas refrigerant with lower pressures which leads to more energy savings and higher equipment efficiency rating (BTU/KWH) for the refrigeration system. A water-cooled condenser has higher cooling efficiency than an air-cooled condenser and is therefore the better choice for a refrigeration system striving for more energy efficiency. Unfortunately, the conventional water-cooled condenser is designed with a water cooling tower to cool the water for cooling the condenser. This type of water-cooled condenser occupies a lot of space and is too expensive to be accepted widely by the public consumer.

The amount of liquid refrigerant flowing into the evaporator from the condenser plays a crucial role in determining the system capacity of a refrigeration system. To ensure stable system capacity during operation, a metering device is used to control the flow of the refrigerant. The metering device used in a conventional system, for example, a thermostatic expansion valve or capillary tubes, controls the flow of the liquid refrigerant coming from a higher pressure condenser to a lower pressure evaporator. A refrigeration system with a conventional metering device will have the evaporator starved when the condenser gets too cold, a condition in which the pressure inside the condenser (head pressure) becomes very low. The result of the evaporator being starved is lower system capacity. To solve this problem, a head pressure controller is installed to prevent the condenser from becoming too cold. Unfortunately this means that the conventional refrigeration system cannot be as energy efficient as desired in cold weather due to the necessity of keeping the system capacity at a sufficient level.

### SUMMARY OF THE PRESENT INVENTION

The present invention addresses the problem by designing a new type of condenser named ES condenser. The ES condenser is modeled after a water-cooled condenser but is much smaller in size and less expensive to make. This new type of condenser makes it possible to manufacture small or medium size water-cooled refrigeration system that have high cooling capacity and at the same time are energy efficient and affordable to the public.

The present invention addresses the above problem by use of a new type of metering device named pump valve which utilizes the electricity power to pump refrigerant liquid from the condenser to the evaporator to prevent the evaporator from being starved when the condenser gets too cold in cold weather and the head pressure too low. The new metering device allows the refrigeration system to operate at its maximum cooling capacity in cold weather without having to sacrifice the system capacity.

A refrigeration system that utilizes the Energy Saving arrangement will be able to achieve high cooling capacity and high energy efficiency and at the same time keep the system at an affordable price to the consumer.

A main object of the present invention is to provide a refrigeration system with a condensing unit and a metering device to enhance the efficiency thereof and to lower energy consumption in the refrigeration system.

Another object of the present invention is to provide a refrigeration system, wherein the condensing unit and the metering device can be used in different refrigeration systems such as freezer, refrigerator or air conditioning (cooling) system, to help the system to save the energy.

Another object of the present invention is to provide a refrigeration system, wherein the condensing unit, which is named as ES (Energy Saving) condenser, provides both water-cooling effect and air-cooling effect to maintain the optimum operation temperature so as to enhance the efficiency in the refrigeration system for saving the energy.

Another object of the present invention is to provide a refrigeration system, wherein the condensing unit is adapted to solve the problem of mineral deposits, which occurs commonly in a water-cooled condenser, so as to reduce the maintenance cost of the refrigeration system.

The condensing unit comprises a finned tube (refrigerant tube attached with fins), a cooling fan, a coiled tube (refrigerant tube coiled), a water reservoir and a water pump. The water reservoir is positioned under the finned tube for storing the water used to wet the finned tube and to collect the wetting water as it falls down from the finned tube for reuse. The water pump pumps the water from the water reservoir to the top of the finned tube to wet the finned tube. As the water falls from the top of the finned tube to the sump, it is cooled by the cooling fan. The cooled wetting water cools the coiled tube which located in the water reservoir as the cold wetting water reaches the water reservoir. On the other hand, the wetted finned tube is cooled continually by the air flow of the cooling fan. In effect, the condensing achieves very high cooling efficiency by utilizing the evaporative-cooled finned tube and the water-cooled coiled tube to raise the efficiency in a refrigeration system for saving the energy.

Mineral deposits are of a concern in a refrigeration system that involves the condensing unit with water-cooled method. The water-cooled coiled tube is in hot when it contacts to the water. Therefore it is more like to be prone to the mineral deposits problem. To make removal of mineral deposits easier, the coiled tube is designed to locate in the water reservoir which has open on its top so that it's easy to access the coiled tube for cleaning the minerals deposited on the coiled tube. The finned tube, on the other hand, is less likely to have the mineral deposits problem. The combination of warm temperature of the finned tube (the refrigerant is cooled to warm by the coiled tube before it getting in the finned tube) and constant moving of the wetting water on the finned tube makes the condition of very few mineral minerals deposits to form on the finned tube. The few mineral deposits will not affect the cooling efficiency of the finned tube for the system working in long time. In short, the special design of the condensing unit mentioned above makes it easy to treat any possible mineral deposits exist in the condensing unit.

The pump valve of the metering device comprises a liquid pump and an electrical motor. The pump valve is controlled by a microcomputer controller to adjust the pumping amount of the refrigerant liquid from the condensing unit to the evaporator. To prevent the evaporator from being starved when the head pressure (the pressure inside the condensing unit) in the refrigeration system is too low, the liquid pump will be speeded up the pumping of the refrigerant into the evaporator. With the pump valve installed, there's no need to install the head pressure control equipment (keeping the condenser being above certain temperatures) to prevent the evaporator being starved since the condensing unit is allowed to be kept cold without affecting the operation of the refrigeration system. In fact, the lower the temperature of the condensing unit, the less energy is needed to operate the refrigeration system and thus energy savings in achieved.

The design of the condensing unit has two purposes: one is to increase the condensing unit cooling efficiency; the other is to solve the problem with mineral deposits in the condensing unit.

To increase the cooling efficiency, the condensing unit incorporates both evaporative-cooled and water-cooled methods. The finned tube, one of the major components of the condensing unit, in effect, looks like an air-cooled condenser which attached with a multitude of fins. Its multitude of fins provides an expanded water evaporation surface area for raising the cooling efficiency. The finned tube works as an evaporative-cooled condenser when it is wetted by the water. The coiled tube, the other major components of the condensing unit, is a refrigerant tube coiled to extend the length of the tube. The coiled tube is placed in the water reservoir to be cooled by the water in the water reservoir. In a refrigeration system with the condensing unit, the hot refrigerant coming from the compressor is cooled by both the water-cooled coiled tube and the evaporative-cooled finned tube. As a result, the cooling efficiency of the condensing unit is very high. This is the first object of the design of the present invention.

Another object of the design is to find a solution to the problem of mineral deposits, which occurs commonly in a water-cooled condenser. The refrigerant gas is very hot as it first exits the compressor. As such, the coiled tube turns hot from the hot refrigerant passing through it. Mineral deposits form when hot coiled tube comes in contact with water. The mineral deposits can be removed easily since the coiled tube is located in the water reservoir with open top. The finned tube, on the other hand, is less prone to the mineral deposit problem because the tube is relatively warm due to the fact that by the time the refrigerant has traveled through the coiled tube it has cooled down to a warm temperature before entering the finned tube. The combination of the lower temperature of the finned tube and the constantly moving of the wetting water makes the condition of less likely for mineral deposits to occur. In the event that any mineral deposits occurs on the finned tube, which may materialize only after many years in use, it can be easily removed with the use of proper tools.

The present invention also includes a unique method of wetting the condensing unit. The wetting method utilizes a small water pump to pump water from the water reservoir through a small hose to the wetting water container situated above the finned tube. The water is collected in the wetting water container until it reaches a certain amount, at which point the water container tilts over and pours down all the water inside the container to wet the finned tube thoroughly. The wetting water is then collected in the water reservoir below the finned tube for reuse. Once the wetting water container is emptied out of water it gets back to the original position to collect water from the water pump again to repeat the wetting process. The successive pouring of the wetting water keeps the surface of the finned tube continually wet. This unique design requires only a small water reservoir for the wetting system to work perfectly. The unique design keeps the condensing in small size. Due to its small size, the condensing unit is ideal for use in small refrigeration system. Due to its high cooling efficiency, reduced size, the condensing unit is also ideal for substituting the conventional types of water-cooled condenser to save the room in a refrigeration system.

The condensing unit has a high level of cooling efficiency. One problem with a condensing unit having high cooling efficiency in the refrigeration system is that the evaporator will be starved during cold weather. To solve the problem of the evaporator from becoming starved, the present invention adopts a new type of metering device named pump valve. This pump valve is special design for preventing the starvation in the evaporator during cold weather. In the help of the pump valve, the refrigeration system achieves energy savings by the condensing unit working in lower temperature without starving the evaporator.

The conventional metering device works as a restrictor. It utilizes the resistance of the valve to limit the amount of the refrigerant being released from the high pressure condenser into the low pressure evaporator. In a refrigeration system with the conventional metering device, the temperature of the condenser needs to be kept in an acceptable range to ensure a sufficient level of the head pressure (the pressure inside the condenser) to prevent the evaporator from being starved, therefore the head pressure control equipment to keep the condenser in a acceptable temperature is necessary if the unit working in cold weather. The pump valve solves the problem of the evaporator being starved, therefore the head control equipment is not necessary in a refrigeration system installed with the pump valve.

The new invention, pump valve, is comprised of a liquid pump and an electrical motor. The narrow and long refrigerant passage (similar to a capillary tube) inside the liquid pump works as a restrictor to limit the amount of the refrigerant flowing from the high pressure condenser into the low pressure evaporator. Besides, the liquid pump works as a driver, it speeds up by the power of the electrical motor to feed more refrigerant from the condenser to the evaporator to prevent the evaporator being starved.

The pump valve is controlled by a microcomputer controller, which has sensors to monitor the condition in the evaporator. If the evaporator is starved, the controller system signals to the pump valve to increase the pumping of the refrigerant from the condenser to the evaporator. With this pump valve, the refrigeration system can operate with a colder condenser (a lower head pressure) for saving the energy without leaving the evaporator in the situation of being starved.

The liquid pump looks like an auger rotates inside a cylinder. The rotator of the liquid pump has a narrow and long passage of the refrigerant liquid under the surface of the rotator. This long and narrow passage is similar to the capillary tube in a refrigeration system, limits the amount of the refrigerant flowing from the high pressure condenser into the low pressure evaporator. The rotators are set in turning motion by the high pressure of the refrigerant which comes from the condenser. No electrical motor power is needed if the head pressure is enough to feed enough refrigerant to the evaporator. When the condenser gets cold, resulting in low head pressure that causes the turning motion of the rotator of the liquid pump going down and evaporator being starved, the liquid pump is then powered by the electrical motor to speed up to feed more refrigerant into the evaporator. The energy used to speed up the pump valve is few, it can be negligible when compared to the energy saved from having the pump valve installed to allow the refrigeration system to operate with lower head pressure.

The condensing unit and the pump valve don't have to be installed together for working properly. The condensing unit can function just as effectively in saving energy when working with a conventional metering device in a refrigeration system if the system works in a warmer place. The pump valve can work just as effectively in saving energy when working in a refrigeration system with to substitute the conventional metering device.

The following is the conclusion of the merits of the condenser of the new invention (comparing to the conventional air-cooled condenser or water-cooled condenser).

1. High cooling efficiency and achievement in energy savings (similar to a conventional water-cooled condenser, the condenser saves energy around 40% in a refrigeration system in hot summers comparing to an air-cooled condenser).

2. Low cost (the Condenser costs around the same as an air-cooled condenser, and costs a lot less than a conventional water-cooled condenser).

3. Easy maintenance (the condenser is as low maintenance as an air-cooled condenser. No chemical treatments are needed for the ES condenser).

4. Small size (suitable for large and small refrigeration units).

5. Helping refrigeration system last longer (having a stable, high efficient condensing unit prevents damages to the system from overloading).

The following is a conclusion of the merits of the metering pump of the new invention (comparing to the conventional metering devices such as thermostatic expansion valve, automatic expansion valve or capillary tube).

1. Less energy consumption (the refrigeration system consumes less energy because it is able to operate in lower head pressure).

2. Savings in cost from not having to install the head pressure control system.

These and other objectives, features, and advantages of the present invention will become apparent from the following detailed description, the accompanying drawings, and the appended claims.

### BRIEF DESCRIPTION OF THE DRAWINGS

FIG. 1 illustrates a refrigeration system with a condensing unit and a metering device according to a preferred embodiment of the present invention.

FIG. 2 illustrates the condensing unit of the refrigeration system according to the above preferred embodiment of the present invention.

FIG. 3 is a schematic view the pump valve of the metering device according to the above preferred embodiment of the present invention.

FIG. 4 is a sectional view of the pump valve according to the above preferred embodiment of the present invention.

FIG. 5 is an enlarged sectional view of the pump valve according to the above preferred embodiment of the present invention.

FIG. 6 is a perspective view of a wetting water container unit according to the above preferred embodiment of the present invention.

### DETAILED DESCRIPTION OF THE PREFERRED EMBODIMENT

The apparatuses and methods for saving energy in a refrigeration system such as air conditioner, freezer or refrigerator system, in accordance with the present invention will be explained in the following drawings.

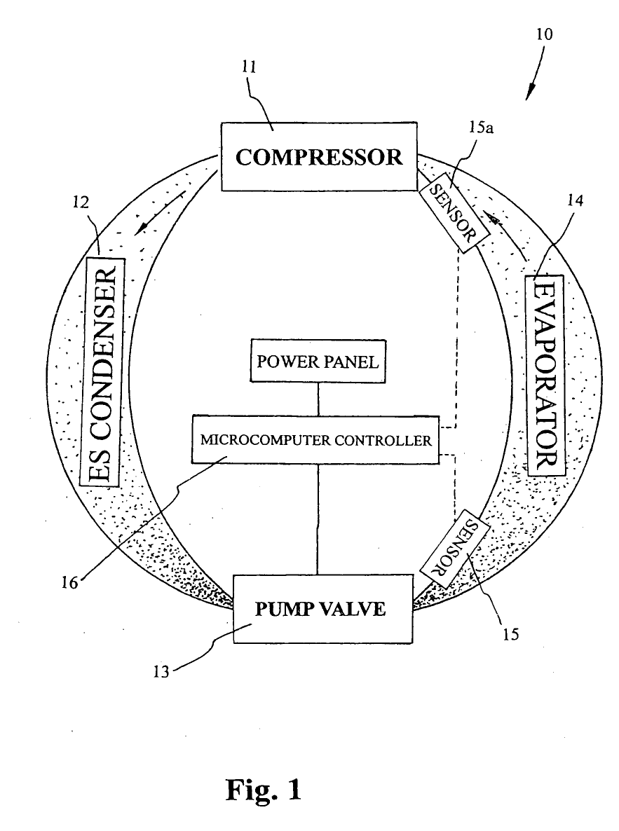

Referring to FIG. 1 of the drawings, a refrigeration system according to a preferred embodiment is illustrated, wherein the refrigeration system comprises a compressor 11, a condensing unit 12, an evaporator 14, and an energy saving arrangement which comprises a water-cooling device and a metering device which is a refrigerant liquid pump. Accordingly, the compressor 11, which is a conventional type of compressor, compresses the less dense refrigerant gas/vapor (the less dark portion of the evaporator) coming out of the evaporator 14. The compressed hot refrigerant gas gets cooled down and is condensed as it passes through the condensing unit 12 and becomes refrigerant liquid (darker portion inside the condenser). The metering device comprises a pump valve 13 feeds a suitable amount of the refrigerant liquid from the condensing unit 12 into the evaporator 14, wherein the evaporator 14 is a conventional type of evaporator. The refrigerant liquid in the evaporator 14 absorbs the heat from the surrounding air (or water). After the refrigerant liquid absorbs heat, it turns into gas and then enters into the compressor 11 to be compressed again for the next refrigeration cycle.

As the heated refrigerant vapor enters the condensing unit 12 from the compressor 11, the refrigerant gas is cooled down as it travels through the two main components of the condensing unit 12. Accordingly, the condensing unit 12 comprises an evaporative-cooled finned tube 22 and a water-cooled coiled tube 23 communicatively extended from the compressor 11 to the finned tube 22 for the refrigerant passing from the compressor 11 to the finned tube 22. Due to its high cooling efficiency, the condensing unit 12 may become too efficient in cold weather. When this happens, the head pressure (the pressure inside the condensing unit 12) will be too low in the cold weather and results in the evaporator 14 being starved. To resolve the problem of the evaporator 14 being starved, the metering device comprises a pump valve 13 used in the system to substitute for the conventional types of metering device (such as thermostatic expansion valve, automatic expansion valve and capillary tube). The pump valve 13 comprises an electrical motor, a liquid pump and a liquid evacuator. The pump valve 13 works as a restrictor to limit the amount of refrigerant liquid being released into the low pressure evaporator 14 from the high pressure condensing unit 12. At the same time, the pump valve 13 works as a driver, using its liquid pump to feed more refrigerant to the evaporator 14 when the evaporator 14 is starved due to the head pressure being too low. There are two temperature sensors 15, 15a installed on the inlet and outlet of the evaporator 14 to connect to a microcomputer controller 16. The microcomputer controller 16 analyses the signals from the temperature sensors 15, 15a, and decides the pumping speed of the pump valve 13 such that an appropriate amount of refrigerant is pumped into the evaporator 14 to prevent the evaporator 14 from being starved. When a refrigeration system is installed with the pump valve 13, it will not need a head pressure control to keep the condensing unit 12 above certain temperature to prevent starvation in the evaporator 14. This means that the refrigeration system can work in lower head pressure and thus consumes less energy.

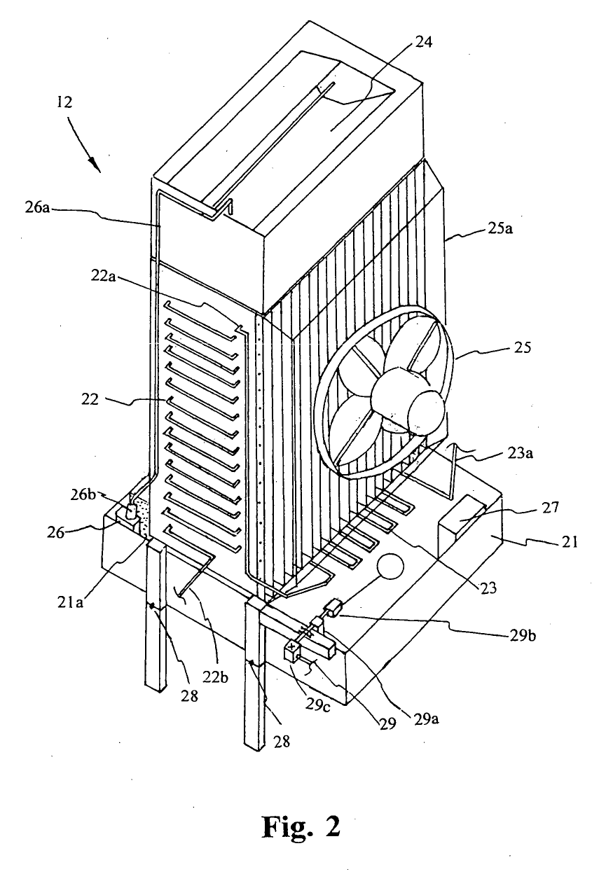

FIG. 2 illustrates the condensing unit 12 of the present invention in the configuration, to which apparatuses and methods are applied in accordance with the present invention.

The water-cooling device is arranged for frequently introducing a predetermined amount of water to a surface of the finned tube 22 for cooling the refrigerant inside the finned tube 22. The cooling device comprises a wetting water container 24, a water reservoir 21, and a water pump 26. The water pump 26 pumps the water as a cooling agent from the water reservoir 21 to the top of the finned tube 22. The water is then released from the top and falls down over the surface of the finned tube 22, and as the water flows down to the water reservoir 21 over the finned tube 22, it is cooled by air flows of a cooling fan 25. The influx of the cooled wetting water lowers the temperature of the water in the water reservoir 21, which in turn cools the coiled tube 23 placed in the water reservoir 21. On the other hand, the wetted finned tube 22 is cooled continually by the air flow from the cooling fan 25.

As illustrated in FIG. 2, the wetting water container 24 is situated on the upside of the finned tube 22 (the appearance of the finned tube is similar to that of an air-cooled condenser). A cooling fan 25 is installed next to the finned tube 22. The water reservoir (sump) 21 is installed under the finned tube 22 for collecting and storing the water used to wet the finned tube 22. The water reservoir 21 is large enough to contain the wetting water falling from the water container 24 to collect it for reuse.

There is a water supply line 29 with a water level controller 29b (float or electronic control methods) to ensure the water in the water reservoir 21 at a constant level. An electric water valve 29a, controlled by a refrigeration control system, can be used to shut off the water supply. A regular manual water valve 29c is installed for manual control. A coiled tube 23 is downwardly extended from the finned tube 22 and located and submerged inside the water reservoir 21 to be cooled by the water in the water reservoir 21. Therefore, the refrigerant, which passes from the compressor 11 to the finned tube 22 through the coiled tube 23, is cooled down at the coiled tube 23 by the water at the water reservoir 21 before the refrigerant enters to the finned tube 22. The water pump 26 pumps the water through the hose 26a from the water reservoir 21 to the water container 24. When the water container 24 is filled with the water from the pump 26 at a certain amount, it becomes unbalanced and automatically tilts down (clockwise turn), then the water flushes out of the water container 24 and pours down to thoroughly wet the finned tube 22 to water-cool the finned tube 22 frequently. After the water holder 24 empties out the water, it flips back (counterclockwise turn) to the original position to collect water again for the next wetting. A good amount of water pours down over the finned tube 22 continually, it keeps the surface of the finned tube condenser 22 constantly wet. The cooling fan 25 blows strong air over the filmed tube to remove the heat from the surface of the wet finned tube 22 to cool the refrigerant inside the finned tube 22. The air flow of the cooling fan 25 cools the finned tube also cools the wetting water falling down to the water reservoir 21 below (when the wetting water falls down to the water reservoir 21, it also mixes the cooled water staying on the surface of the finned tube 22 from last wetting). When the cool wetting water reaches the water reservoir 21, the cooled wetting water cools the coiled tube 23 in the water reservoir 21.

When in operation, the hot refrigerant gas from the compressor 11 flows into the coiled tube 23 via its inlet 23a and is cooled by the coiled tube 23 which cooled by the water in the water reservoir 21 to a warm temperature. The warm refrigerant then enters the finned tube 22 via its inlet 22a to be condensed and subcooled, and then the refrigerant liquid from the outlet 22b of the finned tube 22 travels to the metering device. The finned tube 22, having an elongated fin shape, has a large surface area for water evaporation to better achieve cooling efficiency. The coiled tube 23 is coiled to give it an extended length so that there would be an enough distance for the refrigerant to travel through and to be cooled down. Together with the large surface of the fin tube, the extended length of the coiled tube, the enhancing cooling effects by the fan and water, the condensing unit 12 will enhance very high cooling efficiency.

Mineral deposit problem is of a concern when a hot condensing unit 12 comes in contact with water. The possible mineral deposit problem associated with the finned tube 22 is reduced by the fact that the tube, which is in warm when it contacts to the wetting water. In addition, the constant moving of the wetting water reduces the chance of mineral deposits. Mineral deposits are more likely to occur on the coiled tube 23, which is hot in temperature and is submerged in water. Fortunately, the water reservoir 21 in which the coiled tube 23 has an open on its top for easy to access for cleaning the minerals on the tube. Besides, if it is in need, the water reservoir 21 can be designed to be able move out during cleaning the coiled tube 23 for making very easy to access the coiled tube 23 to do the clean job. The unique design of the condensing unit 12 mentioned above solves the mineral deposits problem commonly associated with the types of water-cooled condenser.

A retainer 21a made of net is installed in the water reservoir 21 to keep out the debris from entering into the water pump 26. Also, a water stirring pump 27 is installed in the water reservoir 21 to stir the water surrounding the coiled tube 23. This is to help raise the cooling efficiency of the coiled tube by dissipating the water away from the coiled tube 23 after it has absorbed the heat from the tube and pushing in the cooler water in the water reservoir 21 that had just flown from the water container 24 above.

In FIG. 2, the water reservoir 21 is designed to be removed easily to make it convenient to reach the coiled tube 23 to remove any mineral buildup on the coiled tube 23 (the coiled tube and the water supply pipe are fixed to the whole unit, are unmovable). There is a plurality of hooks 28 on the legs of the condensing unit 12. The water reservoir 21 is held by hooking its stables onto the hooks 28. When needed, the water reservoir 21 can be easily removed to make room for accessing the coiled tube 23 more conveniently. As the water reservoir 21 is being removed, several components attached to the water reservoir 21, such as the water pump 26 (whose hose connector 26b can be loosened easily before removing the water pump 26), the retainer 21a and the stir pump 27 can also be taken down at the same time to be cleaned when cleans the coiled tube 23.

The condensing unit 12 can operate either in air-cooled or evaporative-cooled mode. In freezing cold areas, a refrigeration system installed with the condensing unit 12 (supposed this system is also installed with the pump valve 13 without the head pressure equipment). When the temperature is very low and the water in the system is frozen, the finned tube 22 can still achieve cooling efficiency by fan air without use of wetting water.

In FIG. 2, the holder 25a of the cooling fan 25 is transparent. Transparent holder 25a makes it easier to see and to make sure the wetting system is functioning perfectly. There is a movable net cover (without showing in this FIG.) to protect the entire condensing unit 12 from damage by foreign materials.

In different refrigeration systems, the size and style of the water reservoir 21, the finned-tube 22, the coiled-tube 23 and other apparatuses in the condensing unit 12 may vary to fit the need of the system. Thus the invention is not only limit to the style shown on this FIG. 2. For example, the water container 24 does not install exactly on top of the finned tube 22. It can be in a separate case with a water channel connected to the funned tube 22 for wetting the finned tube 22.

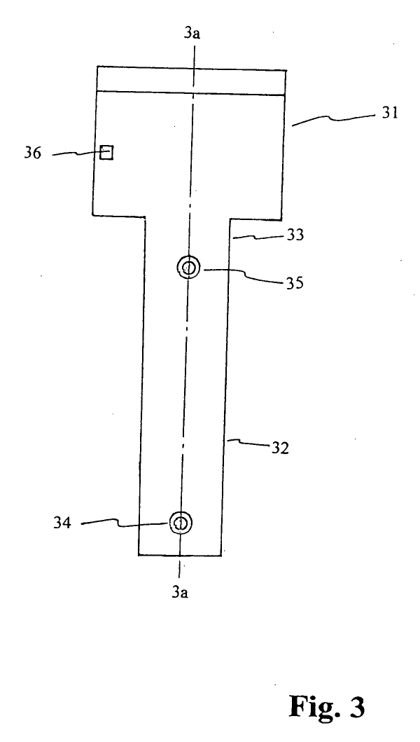

FIG. 3 illustrates the pump valve 13 of the metering device of the present invention. The pump valve 30 comprises an electrical motor 31, a liquid pump 32 and a liquid evacuator (evacuating pump) 33. The refrigerant liquid from the condensing unit 12 enters the liquid pump 32 through an inlet 34 and exits the liquid pump 32 to the evaporator 14 through an outlet 35. The microcomputer controller 16 is connected to the electrical terminal 36 for the supply of power used in the electrical motor 31. To prevent the refrigerant liquid staying inside the electrical motor 31, the pump valve 13 is installed with the electrical motor 31 in the upside and the liquid pump 32 in downside. The liquid evacuator 33 is used to pump the refrigerant liquid from the inside of the electrical motor 31 for preventing condensed refrigerant staying inside the electrical motor 31. The liquid pump 32 is used to pump the refrigerant liquid from the condensing unit 12 to the evaporator 14.

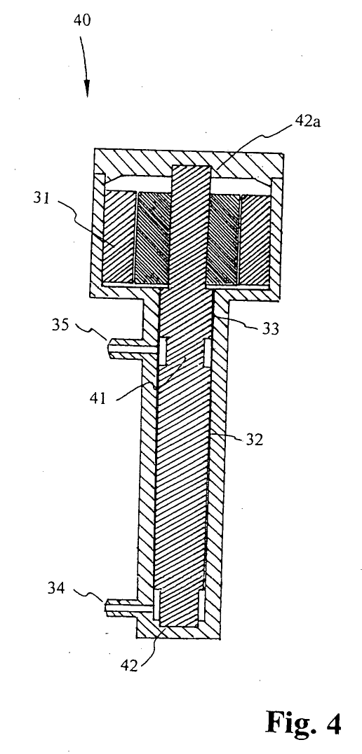

FIG. 4 is a sectional view of the pump valve 13. The pump valve 13 comprises the electrical motor 31, the liquid pump 32 and the liquid evacuator (evacuating pump) 33, as it is mentioned above. The electrical motor 31, the liquid pump 32 and the liquid evacuator (evacuating pump) 33 have same shaft 41 hold by the two terminal sockets 42, 42a. The rotators of the liquid pump 32 and the liquid evacuator 33 are rotated in a cylinder 46 type shell. The inlet 34 and the outlet 35 of the pump valve 13 are the screw type connectors for convenience to connect to the refrigerant tube.

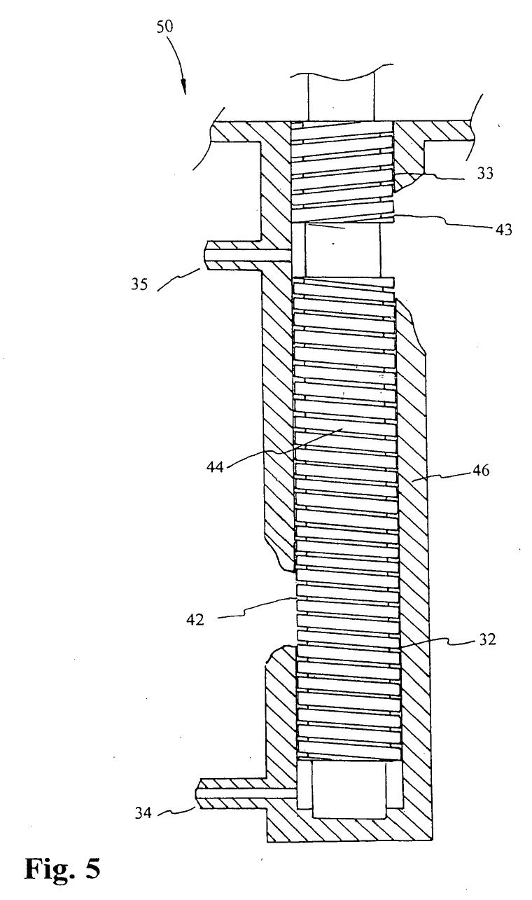

FIG. 5 illustrates of the perspective view of the invention with parts removed to reveal detail of the liquid pump 32 and the liquid evacuator 33 of the pump valve 13. A refrigerant outlet 35 is provided between the liquid evacuator 33 and the liquid pump 32, and an inlet 34 is provided in another end of the liquid pump 32. The rotator 44 of the liquid pump 32 looks like an auger. When the rotator 44 rotates inside the cylinder 46 of the liquid pump 32, it push the refrigerant liquid from the inlet 34 to the outlet 35 of the pump valve 113 through the tiny and long refrigerants passage 42 at the surface of the rotator 44. There is a similar tiny refrigerant passage 43 indent at the surface of the rotator 44 of the liquid evacuator 33. The refrigerant passage 43 leads the refrigerant liquid out of the electrical motor 31 to the outlet 35 when the rotator 44 in rotation (the rotation of the rotor 44 of the liquid pump 32 push the liquid refrigerant up direction, the rotation of the rotor 44 of the liquid evacuator 33 push the liquid refrigerant down direction). The purpose of the liquid evacuator 33 is to pump out the refrigerant gas out the room of the electrical motor 31, thus prevents the electrical motor 31 from having the refrigerant liquid staying inside. During the refrigeration system working, the refrigerant liquid entering through the inlet 34 from the condensing unit 12 is pumped by the liquid pump 32 towards the evaporator through the outlet 35. The circumferences of the rotator 44 of the liquid pump 32 are slightly smaller than the interior circumference of the cylinder 46 of liquid pump 32 such that there is almost no gap in between. When the refrigerant enters, it's forced to travel through the long, tiny, spiral-like refrigerant channel 42 created under the surface of rotator 44. This long, tiny, spiral-like refrigerant channel 42 works like a capillary tube, limiting the flow of the refrigerant running from the high pressure condensing unit 12 to the low pressure evaporator 13, and it works as a liquid pump 32 when the liquid is speeded up by the electrical motor 31. When the refrigeration system is in operation, the rotator 44 of the liquid pump 32 is pushed to rotate by the high pressure of the refrigerant coming from the condensing unit 12. No motor power is needed here to rotate the rotator 44. However, if the head pressure (the pressure inside the condensing unit 12) in the refrigeration system is too low (lower than a threshold pressure), there will be not enough pressure for the liquid pump 32 to get enough pumping speed to feed enough refrigerant from the condensing unit 12 to the evaporator 14. This is similar to the situation when the evaporator 14 of the refrigeration system with a capillary tube, the evaporator 14 will be starved due to the low head pressure. A solution to prevent starvation in the evaporator 14 in a refrigeration system with a capillary tube is by keeping the condensing unit 12 warmer for raising the head pressure. However, such method result in the refrigeration system operates in the higher condenser temperature, which in turn requires more energy to operate. The refrigeration system installed with the pump valve 13 of the present invention can prevent starvation in the evaporator 14 by using the electrical motor 31 to increase the pumping speed of the liquid pump 32 to feed more refrigerant from the condensing unit 12 into the evaporator 14. This allows the refrigeration system to function even with low condenser temperature. With the pump valve 13 installed, the head pressure control which is used for keeping the condensing unit 12 warmer, will no longer be needed in the system. Very little electricity is consumed by the electrical motor 31 to speed up the pumping speed. The amount of energy consumed is negligible when comparing to the amount of energy saved by having the pump valve 13 installed in the refrigeration system. The pump valve 13 is a simple, easy-to-install device suitable for use in the refrigeration system for saving the energy. In effect, the pump valve 13 can use for different purpose, for example, in a multiple-room cooling refrigeration system, the pump valve can be installed in each room to better control the specific temperature of each room.

When installing the pump valve 13 in a refrigeration system, the pump valve 13 is installed in a warmer area for keeping the electrical motor 31 warm to prevent the refrigerant gas from being condensed inside the electrical motor 31. In addition, the refrigerant tube installed between the outlet 35 of the pump valve 13 comprises a short capillary tube as to prevent the refrigerant liquid from evaporating inside the pump valve 13, causing the electrical motor 31 to become too cold. In short, the method used to ensure the electrical motor 31 can operate in good conditions without the refrigerant condensed inside the electrical motor 31 include: maintaining the electrical motor 31 in warm temperature and in low pressure; utilizing the evacuating pump to pump out any refrigerant liquid from the room of the electrical motor 31; having the capillary tube between the outlet of the pump valve 13 and the evaporator 14 to prevent the refrigerant liquid evaporated inside the pump valve 13 causing the electrical motor 31 to become too cold.

The pump valve 13 of the present invention creates equilibrium pressure between the condensing unit 12 and the evaporator 14 by having the refrigerant travel through the long, narrow refrigerant channel 42 between the condensing unit 12 and the evaporator 14 during the off cycle of the refrigeration system. This feature has advantage that the compressor 11 can start with less torque after an off cycle.

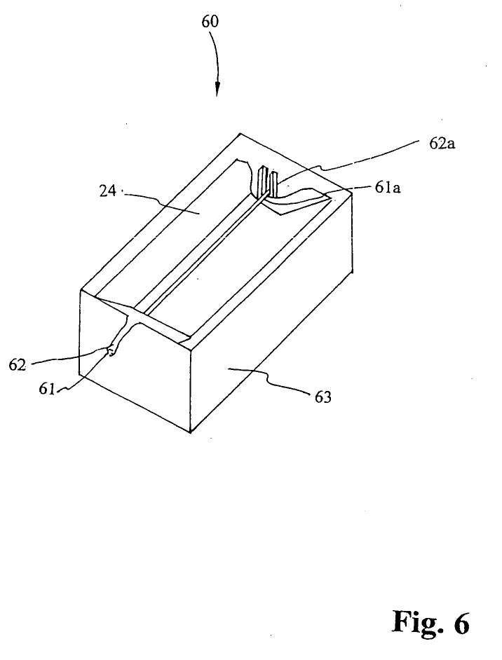

FIG. 6 is a perspective view of the wetting water container unit 60. The water container 24 is pivoted by its handles 61, 61a that hold onto the sockets 62 & 62a which molded into the holding rectangular walls 63. The turntable wetting water container 24 acts like a lever. When the water coming from the water pump reaches in a certain level, the water inside the container makes the wetting water container 24 unbalanced, then the wetting water container 24 tips over (clockwise turn, due to the right side of the wetting container 24 being heavy) and pours out all the water inside the wetting water container 24 over the finned tube 22 below. Once it has emptied out its content, the wetting water container 24 turns back (counterclockwise turn, due to the left side of the wetting water container 24 being heavier) to its original position to collect more water for the next wetting cycle. The purpose of this invention, the wetting water container 24, is to collect water in low water flow into a large pool and then release it in a quick motion to wet the finned tube 22 thoroughly. In different refrigeration systems, the size and style of the wetting water container 24 may vary to fit the need of the system. Thus the invention is not only limit to the style shown in FIG. 6.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A refrigeration system, comprising:
an evaporator;
a compressor compressing a refrigerant in gas form coming out of said evaporator;
a condensing unit which comprises a finned tube guiding said refrigerant from said compressor back to said evaporator; and
an energy saving arrangement which comprises a water-cooling device frequently introducing a predetermined amount of water to a surface of said finned tube to water-cool said refrigerant within said finned tube for enhancing a cooling efficiency of said condensing unit while being energy efficient.

2. The refrigeration system, as recited in claim 1, wherein said water-cooling device comprises a wetting water container supported above said finned tube for containing a predetermined amount of water, wherein when said water container is filled with a certain amount of said water, said water container is automatically tilted for flushing said water towards said finned tube so as to water-cool said finned tube frequently.

3. The refrigeration system, as recited in claim 2, wherein said water-cooling device further comprises a water reservoir positioned below said finned tube for collecting said water being poured from said water container, and a water pump pumping said water from said water reservoir to said water container so as to recycling use said water to cool down said refrigerant within said finned tube.

4. The refrigeration system, as recited in claim 3, wherein said condensing unit further comprises a coiled tube communicatively extended from said compressor to said finned tube for said refrigerant passing thereto, wherein said coiled tube is downwardly extended to submerge at said water within said water reservoir such that when said refrigerant travels along said coiled tube, said refrigerant within said coiled tube is firstly cooled by said water at said water reservoir before entering to said finned tube.

5. The refrigeration system, as recited in claim 4, wherein said water-cooling device further comprises water stirring pump installed in said water reservoir for stirring said water surrounding said coiled tube for dissipating heat absorbed by said water, a water supply line for supplying said water from a water supply into said water reservoir, and a water level controller maintaining water in said water reservoir at a constant level.

6. The refrigeration system, as recited in claim 5, wherein said condensing unit further comprises a cooling fan is supported next to said finned tube for generating an air-cooled effect at said finned tube and cooling said water introduced at said surface of said finned tube.

7. The refrigeration system, as recited in claim 1, wherein said energy saving arrangement further comprises a pump valve communicatively linking between said condensing unit and said evaporator for controllably pumping said refrigerant in liquid form from said condensing unit to said evaporator.

8. The refrigeration system, as recited in claim 6, wherein said energy saving arrangement further comprises a pump valve communicatively linking between said condensing unit and said evaporator for controllably pumping said refrigerant in liquid form from said condensing unit to said evaporator.

9. The refrigeration system, as recited in claim 7, wherein said pump valve comprises a liquid pump which has an inlet communicating with said condensing unit and an outlet communicating with said evaporator and comprises a cylinder and a rotator rotatably disposed in said cylinder, and an electrical motor driving said rotator to rotate within said cylinder, wherein a spiral refrigerant passage is indently provided at a surface of said rotator in such a manner that when said rotator is driven to rotate, said refrigerant is guided to flow along said refrigerant passage from said inlet to said outlet.

10. The refrigeration system, as recited in claim 8, wherein said pump valve comprises a liquid pump which has an inlet communicating with said condensing unit and an outlet communicating with said evaporator and comprises a cylinder and a rotator rotatably disposed in said cylinder, and an electrical motor driving said rotator to rotate within said cylinder, wherein a spiral refrigerant passage is indently provided at a surface of said rotator in such a manner that when said rotator is driven to rotate, said refrigerant is guided to flow along said refrigerant passage from said inlet to said outlet.

11. The refrigeration system, as recited in claim 9, wherein said pump valve further comprises a microcomputer controller controlling an operation of said electrical motor, wherein when a pressure inside said condensing unit is lower than a threshold pressure, said electrical motor is automatically activated to actuate said liquid pump for pumping said refrigerant from said condensing unit to said evaporator.

12. The refrigeration system, as recited in claim 10, wherein said pump valve further comprises a microcomputer controller controlling an operation of said electrical motor, wherein when a pressure inside said condensing unit is lower than a threshold pressure, said electrical motor is automatically activated to actuate said liquid pump for pumping said refrigerant from said condensing unit to said evaporator.

13. A refrigeration system, comprising:
an evaporator;
a compressor compressing a refrigerant in gas form coming out of said evaporator;
a condenser; and
a pump valve having an inlet communicating with said condensing unit and an outlet communicating with said evaporator for controllably pumping said refrigerant in liquid form from said condensing unit to said evaporator.

14. The refrigeration system, as recited in claim 13, wherein said pump valve comprises a cylinder and a rotator rotatably disposed in said cylinder, wherein a spiral refrigerant passage is indently provided at a surface of said rotator in such a manner that when said rotator is rotated, said refrigerant is guided to flow along said refrigerant passage from said inlet to said outlet.

15. The refrigeration system, as recited in claim 15, wherein said pump valve further comprises an electrical motor driving said rotator to rotate within said cylinder.

16. The refrigeration system, as recited in claim 15, wherein said pump valve further comprises a microcomputer controller controlling an operation of said electrical motor, wherein when a pressure inside said condensing unit is lower than a threshold pressure, said electrical motor is automatically activated to actuate said liquid pump for pumping said refrigerant from said condensing unit to said evaporator.

17. A method of enhancing an efficiency of a refrigeration system which comprises a compressor, an evaporator, and a condensing unit comprising a finned tube extending to said evaporator and a coiled tube extended to said compressor, wherein the method comprises the steps of:
(a) communicatively linking a finned tube of said condensing unit to said evaporator to guide a refrigerant passing from said condensing unit to said evaporator;
(b) communicatively linking a coiled tube of said condensing unit to said compressor to guide said refrigerant passing from said compressor to said condensing unit; and
(c) frequently introducing a predetermined amount of water to a surface of said finned tube to water-cool said refrigerant within said finned tube for enhancing a cooling efficiency of said condensing unit.

18. The method, as recited in claim 17, wherein the step (c) comprises the steps of:
(c.1) flushing said water on top of said finned tube;
(c.2) collecting said water by water reservoir which is positioned below said finned tube;
(c.3) cooling down said refrigerant within said coiled tube by submerging said coiled tube at said water within said water reservoir; and
(c.4) pumping said water from said water reservoir to said top of said finned tube for re-flushing said finned tube.

19. The method, as recited in claim 17, further comprising a step of controllably pumping said refrigerant in liquid form from said condensing unit to said evaporator via a pump valve.

20. The method, as recited in claim 19, wherein when a pressure inside said condensing unit is lower than a threshold pressure, an electrical motor is automatically activated to actuate said liquid pump for pumping said refrigerant from said condensing unit to said evaporator.
